(19) United States
(12) Patent Application Publication
(10) Pub. No.: US 2004/0153597 A1
(43) Pub. Date: Aug. 5, 2004

(54) Communication control semiconductor device and interface system

(76) Inventors: Toshinobu Kanai, Tokyo (JP); Masao Naruse, Kodaira (JP); Naoki Hattori, Hitachi (JP)

Correspondence Address: Miles & Stockbridge, Suite 500, 1751 Pinnacle Drive, McLean, VA, 22102-3833, US

(21) Appl. No.: 10/473,079

(22) PCT Filed: Mar. 20, 2002
(86) PCT No.: PCT/JP02/02641

(30) Foreign Application Priority Data
Mar. 27, 2001 (JP) 2001-090616

(51) Int. Cl. G06F 13/14

(52) U.S. Cl. 710/305

(57) ABSTRACT

Host control means (23) which performs communication control as a host, and function control means (24) which performs communication control as a function, are mounted on one semiconductor chip. With its mounting, the host control means and the function control means are configured so as to be able to operate simultaneously. There are further provided an input/output terminal to and from which a data signal transmitted/received by communication control operations of these control means, switching means (29) connected to the input/output terminal and capable of switching a path through which a transmit/receive data signal passes upon communications under the control of the host control means, and a path through which the transmit/receive data signal passes upon communications under the control of the function control means, and a switching control register (27C) which controls the state of the switching means.

### TECHNICAL FIELD

The present invention relates to a communication control technology and a technology effective if applied to an interface circuit between a computer and peripheral devices thereof. The present invention relates to a communication control semiconductor device for controlling communications between electronic devices connected via a serial bus based on, for example, the USB (Universal Serial Bus) standard or the IEEE1394 (Institute of Electrical and Electronics Engineers 1394) standards, and a technology effective for application to an interface system using the same.

### BACKGROUND ART

As interface standards used between a computer and its peripheral devices, there are known various standards such as an SCSI (Small Computer System Interface), a Fibre Channel in addition to the USB standard and the IEEE1394 standards. Of these, the USB standard and the IEEE1394 standards are standards for serially transmitting and receiving data via a cable and feature that since the number of signal lines is small, a cable is thin and connectors are also small.

A USB interface system comprises a CPU and a memory, and a control chip, buffer memories, connectors, etc. The connectors to which a cable is connected, are different in shape between one connected with host device such as a computer, and one connected with device equipment such as a peripheral device. It is thus possible to easily prevent false connections. Therefore, it was common practice that electronic equipment provided with a conventional interface based on the USB standard had only the function of either a USB host or a USB device.

However, such a configuration was accompanied by a problem that it was infeasible to communicate by connecting USB devices to one another. Consequentially, a USB interface system has been proposed which is configured in such a manner that as shown in FIG. 12 by way of example, two connectors 212a and 212b and a selector switch 210 are provided to detect whether a device is connected to any connector and thereby automatically perform switching to the selector switch, and when a host device is connected, it performs communications as device equipment, whereas when device equipment is connected, it performs communications as a host device (Japanese Unexamined Patent Publication No. 2000-209238). Thus, the invention of prior application has an advantage in that device equipment like a digital camera and a printer are connected to one another to make it possible to directly transfer data.

However, the invention of prior application is accompanied by a problem that despite that it includes a function that performs communications as a host device and a function that performs communications as device equipment, both functions cannot be activated effectively, and since only one of the functions is used, it is difficult to construct a free network system. Described specifically, a plurality device equipment can be connected to a host device via relay devices or repeaters called hubs in the case of the USB standard. However, there is provided a constraint that the number of connectable devices is 127 at the maximum and the number of stages of hubs is five at the maximum. Even if devices to which the invention of prior application is applied, are used, a network cannot be constructed beyond the constraint.

Electronic equipment to which the conventional interface system based on the USB standard is applied, is accompanied by a problem that once a network system is constructed, each device capable of performing data communications is fixed, and when communications are made between ones other than between the devices set in advance, it is necessary to physically re-connect cables. The above problem arises in a manner similar not only to a device provided with an interface system based on the USB standard but also to other interface standard such as the IEEE1394 standards, which has provided a communication system between a host device and device equipment.

An object of the present invention is to provide an interface system capable of constructing a free network system beyond the original constraint set based on the interface standard such as the USB standard, and a communication control semiconductor device employed in the interface system.

Another object of the present invention is to provide an interface system capable of transmitting and receiving data between predetermined devices without re-connecting a cable, and a communication control semiconductor device employed in the interface system.

A further object of the present invention is to provide an interface system capable of transmitting and receiving data between predetermined devices which could not be connected so far, and a communication control semiconductor device employed in the interface system.

The above, other objects and novel features of the present invention will become apparent from the description of the present specification and the accompanying drawings.

### DISCLOSURE OF THE INVENTION

Summaries of representative ones of the inventions disclosed in the present application will be explained as follows:

A communication control semiconductor device of a first invention according to the present application is provided wherein host control means used as first control means which performs communication control as a host (master device), and function control means used as second control means which performs communication control as a function (slave device) are mounted on one semiconductor chip, and the host control means and the function control means are configured so as to be able to operate simultaneously.

According to the above means, since the host control means and the function control means can be operated simultaneously, both a connector for connecting a host device and a connector for connecting a function device are provided to enable transmission/reception of data between both devices, whereby a free network can be constructed.

Desirably, there are provided a first buffer memory which temporarily stores data transmitted/received by the host control means, and a second buffer memory which temporarily stores data transmitted/received by the function control means. Further, the host control means and the function control means are respectively provided with control registers set by third control means. The host control means and the function control means are connected to the third control means via an internal bus. The first buffer memory and the second buffer memory are indirectly connected to the internal bus via the control registers. Thus, a connecting window to the internal bus can be shared between the buffer memories and the control registers, and a circuit's occupied area can hence be reduced.

More desirably, there are provided a first buffer memory which temporarily stores data transmitted/received by the host control means, and a second buffer memory which temporarily stores data transmitted/received by the function control means. Further, the host control means and the function control means are respectively provided with control registers set by third control means. The host control means and the function control means are connected to the third control means via an internal bus. The first buffer memory is directly connected to the internal bus, and the second buffer memory is indirectly connected to the internal bus via the corresponding control register. Thus, the time required to transfer data can be shortened on the first buffer memory side directly connected to the internal bus. On the second buffer memory side connected to the internal bus via the control register, a connecting window to the internal bus can be shared between the buffer memories and the control registers, and a circuit's occupied area can hence be reduced.

A communication control semiconductor device of a second invention according to the present application is provided which comprises: host control means used as first control means for performing communication control as a host (master device); function control means used as second control means and performing communication control as a function (slave device); an input/output terminal to and from which each of data signals transmitted/received according to communication control operations of these control means is inputted/outputted; switching means connected to the input/output terminal and capable of switching a path through which a transmit/receive data signal passes upon communications under the control of the host control means, and a path through which the transmit/receive data signal passes upon communications under the control of the function control means; and a switching control register which controls the state of the switching means.

According to the above means, since the data can be transmitted and received even to and from either a host device or a function device by simply changing the setting of the switching control register, a system can be realized which is capable of automatically recognizing the other party and thereby transmitting and receiving the data.

Desirably, third control means is provided which effects a setting on the switching control register. Thus, there is no need to externally effect the setting on the switching control register. A path, a port and an external terminal used for a signal for setting the switching control register become unnecessary, and hence the configuration of the device becomes simple.

More desirably, the host control means and the function control means are respectively provided with control registers set by the third control means, and these control registers and the switching control register are respectively placed in different positions in an address space of the third control means. Thus, there is no need to output a signal for designating or specifying whether any control register should be selected, from the third control means, and hence circuit design becomes easy. Owing to the setting of one control register, the other register can be set when the corresponding control means is operating, and the throughput of a system can hence be improved.

The host control means and the function control means are connected to the third control means via an internal bus and respectively provided with a first buffer memory which temporarily stores data transmitted/received by the host control means, and a second buffer memory which temporarily stores data transmitted/received by the function control means. The first buffer memory is directly connected to the internal bus, and the second buffer memory is connected to the internal bus via the control register. Thus, the time required to transfer the data can be shortened on the first buffer memory side directly connected to the internal bus. On the second buffer memory side connected to the internal bus via the control register, a connecting window to the internal bus can be shared between the buffer memories and the control registers, and a circuit's occupied area can hence be reduced.

There are further provided a first input/output terminal to and from which a transmit/receive data signal is inputted/outputted, and a second input/output terminal to and from which a transmit/receive data signal is inputted/outputted. The host control means is provided with a first port corresponding to the first input/output terminal and a second port corresponding to the second input/output terminal. The second port and a port of the function control means are configured so as to be connectable to the second input/output terminal via the switching means. Thus, any of host devices or function devices can be connected to the second input/output terminal, and the degree of freedom of a system configuration is hence improved.

Moreover, there are provided one host control means, two or more function control means, and three or more input/output terminals to and from which a transmit/receive data signal is inputted/outputted. The host control means and one of the two or more function control means may be configured so as to be connectable to any one of the input/output terminals via the switching means. Thus, an interface system can be configured which is capable of simultaneously performing transmission/reception of data between two or more host devices and one function device.

An interface system of a third invention according to the present application comprises a communication control semiconductor device having such a configuration as described in the second invention, a first connector connectable to a host device, a second connector connectable to a function device, and external switching means connected between a transmit/receive data input/output terminal of the communication control semiconductor device and the first connector and the second connector. The external switching means is configured so as to be controlled in conjunction with the switching means provided inside the communication control semiconductor device. Thus, a system can be configured wherein host devices or function devices can always be connected to the two connectors, and data can be transmitted and received between predetermined devices without re-connecting a cable.

Further, an interface system of another invention according to the present application comprises a communication control semiconductor device having such a configuration as described in the second invention, a first connector connectable to a host device, two or more second connectors connectable to a function device, and external switching means connected between a transmit/receive data input/output terminal of the communication control semiconductor device and any one of the second connectors. The external switching means is configured so as to be controlled in conjunction with the switching means provided inside the communication control semiconductor device. Thus, a computer system or a computer network can be configured which is capable of simultaneously performing transmission/reception of data between two or more host devices and one function device.

Desirably, the external switching means is configured such that a connected state is switched by a signal outputted from a general purpose port provided in the communication control semiconductor device. Thus, the external switching means can be controlled without providing a terminal for outputting a signal for controlling the external switching means within the communication control semiconductor device.

The external switching means and the switching means provided inside the communication control semiconductor device may be configured such that connected states are switched based on a common control signal outputted from the switching control register provided inside the communication control semiconductor device. Thus, there is no need to perform a setting for outputting a signal for controlling the external switching means in addition to a setting to the switching control register, which is carried out to control the switching means lying inside the communication control semiconductor device. Hence the load on third control means is lightened and the time necessary for the setting is also shortened.

### BRIEF DESCRIPTION OF THE DRAWINGS

FIG. 1 is a block diagram showing a first embodiment illustrative of a communication control LSI where the present invention is applied to the USB standard, and an interface system using the communication control LSI;

FIG. 2 is a block diagram illustrating a second embodiment where the present invention is applied to a communication control LSI employed in an interface system based on the USB standard;

FIG. 3 is a block diagram showing a configurational example of an interface system using the communication control LSI according to the second embodiment;

FIG. 4 is an address map showing the layout of control registers and a switching control register in the communication control LSI of the second embodiment on a CPU address space;

FIG. 5 is a block diagram illustrating a third embodiment illustrative of a communication control LSI where the present invention is applied to the USB standard, and an interface system using the communication control LSI;

FIG. 6 is a block diagram depicting another configurational example of the interface system using the communication control LSI of the third embodiment;

FIG. 7 is a block diagram showing a fourth embodiment illustrative of a communication control LSI where the present invention is applied to the USB standard, and an interface system using the communication control LSI;

FIG. 8 is a block diagram depicting a fifth embodiment illustrative of a communication control LSI where the present invention is applied to the USB standard, and an interface system using the communication control LSI;

FIG. 9 is a block diagram showing a configuration of an interface based on the USB standard and the state of connections between two USB devices;

FIG. 10 is a block diagram illustrating one example of a network configured using USB devices to which the present invention is applied;

FIG. 11 is a block diagram depicting one example of the manner in which a USB device and another USB device to which the present invention is applied are connected; and

FIG. 12 is a block diagram showing one example of a conventional USB interface system.

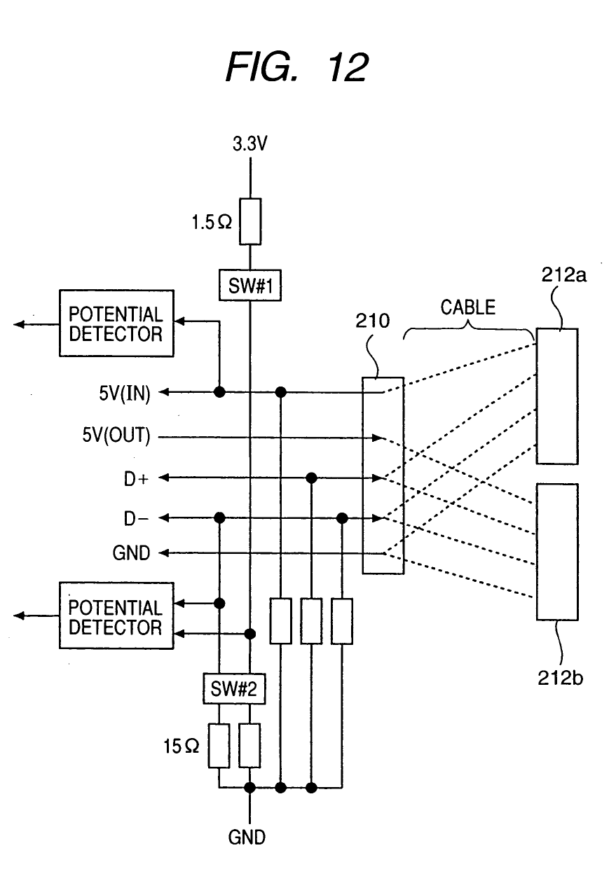

### BEST MODE FOR CARRYING OUT THE INVENTION

Preferred embodiments of the present invention will hereinafter be described based on the accompanying drawings.

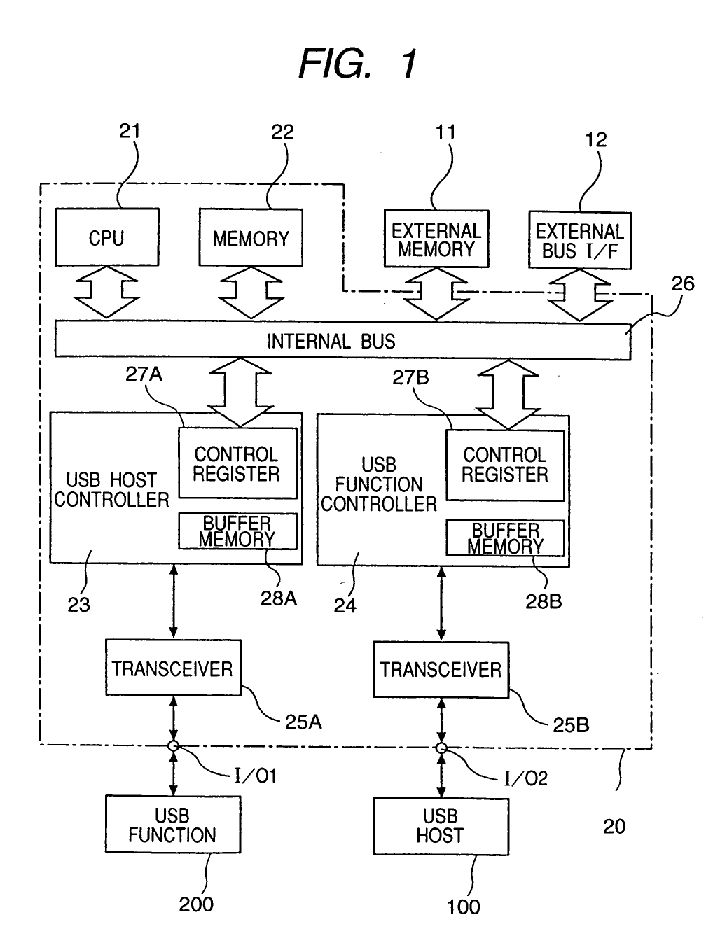

FIG. 1 shows a first embodiment illustrative of a communication control LSI (Large Scale Integration) where the present invention is applied to an interface system based on the USB standard, and an interface system using the communication control LSI.

Incidentally, in the present specification, devices called “device equipment” in the specification of prior application, and electronic equipment equivalent to peripheral devices in general will be called “function devices”. That is, they indicate ones containing them although they are different in the way to denominate them. When the devices function as apparatuses or equipment on the transmission side of data due to the application of the present invention even if they are ones called “peripheral devices” in general, they will be called “hosts or master devices” in the present specification. When the devices function as apparatuses or equipment on the receiving side of data due to the application of the present invention even if they are ones generally called “host devices” in reverse, they will be called “function or slave devices”.

In the embodiment shown in FIG. 1, a central processing unit (hereinafter called “CPU”) 21 and a memory 22 comprising a ROM storing therein a program to be executed by the CPU 21, and fixed data, or a RAM for providing a working area of the CPU 21, or the like, a host controller 23 having a control function, which performs communications as a USB host, a function controller 24 having a control function, which performs communications as a USB function, a first transceiver 25A which performs transmission/reception of a signal in accordance with the instructions of the host controller 23, and a second transceiver 25B which performs transmission/reception of a signal in accordance with instructions of the function controller 24 are formed on one semiconductor chip like monocrystal silicon and constitute a communication control LSI 20.

Of the circuit blocks referred to above, the CPU 21, the memory 22, the host controller 23 and the function controller 24 are connected to one another by an internal bus 26. Further, an external memory 11 and an external bus interface circuit 12 are connectable to the internal bus 26. The first transceiver 25A and the second transceiver 25B are respectively connected to discrete connectors via input/output ports I/O1 and I/O2. The communication control LSI 20, and external memory 11 and external bus interface circuit 12 are mounted on one print circuit board and configured as a board system.

The host controller 23 and the function controller 24 are respectively provided with control registers 27A and 27B and buffer memories 28A and 28B each comprising an FIFO (First-in First-out) type memory or the like. The host controller 23 and the function controller 24 respectively have the function of communicating with function devices or host devices in accordance with a predetermined protocol when a control code, a code for designating a transfer mode, or the like is set to the control registers 27A and 27B.

Now, as communication schemes executed by the host controller 23 and the function controller 24, may be mentioned, an isochronous transfer suitable for the case in which a real-time property is required, an interrupt transfer suitable for the case in which a data size is small, a bulk transfer suitable for the case in which a large amount of data are transferred asynchronously, and a control transfer used to transfer information necessary for a re-configuration or the like with control and detachment of a function device. Whether the host controller 23 and the function controller 24 perform communications in accordance with any of the transfer modes, is determined according to the codes set to the control registers 27A and 27B.

The control registers 27A and 27B are placed in different positions in an address space of the CPU 21, and the CPU 21 sets the control code or the like to each of the control registers 27 and 27B, thereby making it possible to operate the host controller 23 and the function controller 24 in parallel. That is, there is also known a system for laying out the control registers 27A and 27B in the same position in the address space of the CPU 21. In the case of such a system, there is a need to output a signal for designating whether any one of the control registers 27A and 27B should be selected, from the CPU 21. However, such a signal becomes unnecessary by placing the control registers 27A and 27B in the different positions in the address space, and circuit design becomes easy. Further, the other register can be set while one of the control registers is being operated in accordance with the control code set to the one control register, whereby the throughput of the system is improve.

For example, a code for designating whether the transfer of data should be done in any one of transfer modes prepared in advance, address information indicative of whether data from any address to any address in the memory 22 should be transmitted upon data transmission, the length of data (packet), the presence or absence of interrupt control, etc. are also set to the control registers 27A and 27B. Incidentally, a protocol is provided for communications based on the USB standard, and the host controller 23 and the function controller 24 execute communication control in accordance with the protocol. However, the description of the protocol is omitted because the protocol is not directly related to the present invention.

Although not restricted in particular, the present embodiment is configured in such a manner that data transmitted/received between the CPU and each external device is transferred between the external device and the CPU via the control registers 27A and 27B and the buffer memories 28A and 28B. The buffer memories 28A and 28B may be provided between the transceivers 25A and 25B and the internal bus 26 to enable data transfer without via the control registers 27A and 27B. Each of the transceivers 25A and 25B comprises a transmitting driver circuit for driving a signal line for a USB cable by a voltage to thereby transmit a signal, and a receiving driver circuit for detecting the potential of the signal sent via the USB cable to thereby discriminate the signal.

In the USB interface LSI according to the present embodiment, the host controller 23 and the function controller 24 are discretely provided, their control registers 27A and 27B are placed in the different positions in the address space, and the two input/output ports I/O1 and I/O2 are provided. Therefore, the interface LSI behaves as a USB host device and is capable of communicating with an external USB function device 200. Further, the interface LSI behaves as a USB function device and is capable of communicating with an external USB host device 100. The USB function device 200 and the USB host device 100 are simultaneously connected to each other to enable communications in parallel. Such a function is a function that is not contained in the conventional USB interface.

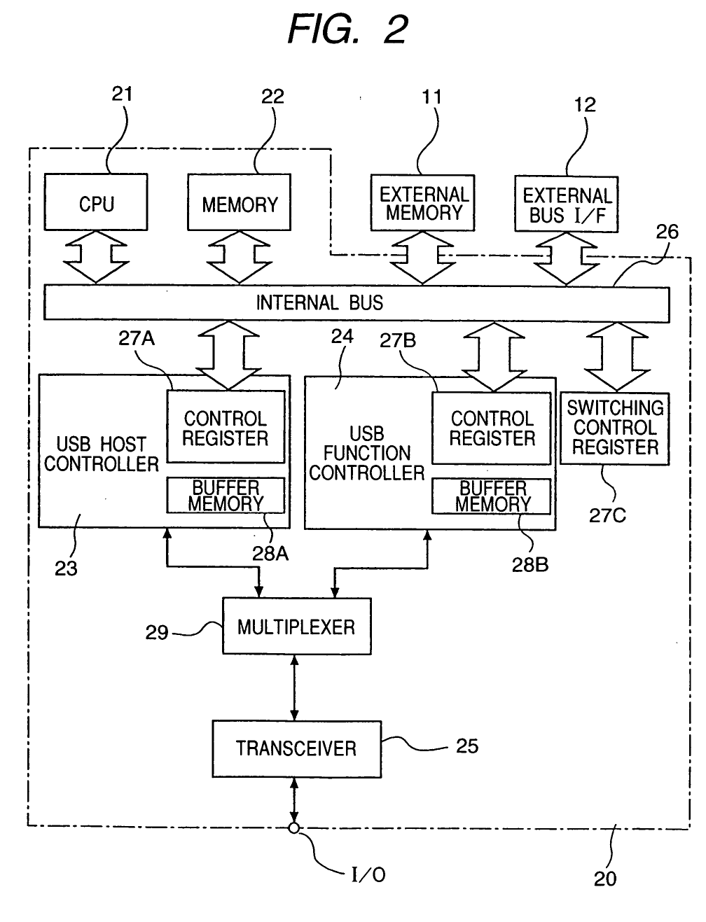

FIG. 2 shows a second embodiment illustrative of a communication control LSI where the present invention is applied to an interface system based on the USB standard, and an interface system using the same.

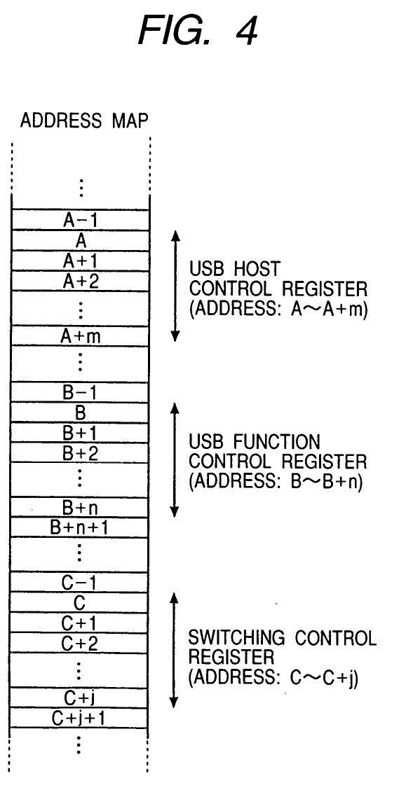

In the present embodiment, the transceivers 25A and 25B employed in the embodiment shown in FIG. 1 are combined into one transceiver 25. A multiplexer 29 is provided between the transceiver 25 and the host controller 23 and function controller 24. Further, a switching control register 27C for controlling the state of the multiplexer 29 is provided. The switching control register 27C is disposed at a different position in an address space of a CPU 21 in a manner similar to the control registers 27A and 27B as shown in FIG. 4. Setting control registers 27A, 27B and 27C by the CPU 21 enables execution of both the operations of the host controller 23 and function controller 24 and control of the multiplexer 29 in parallel.

Since the USB interface LSI according to the present embodiment is provided with the host controller 23 and multiplexer 29 and the switching control register 27C for controlling the state thereof, it is capable of properly communicating with either a host device or a function device connected thereto by setting the switching control register 27C upon power turning-on or in operation, or changing its setting during the operation.

Means for detecting whether either the host device or the function device is being connected is not essential for the present embodiment. However, even if devices connected to USB connectors are switched by a user where such a means is provided, a system can be realized which is capable of automatically detecting and recognizing its switching, changing the setting of the switching control register and thereby performing transmission/reception of data.

Incidentally, one will suffice for an address for designating the switching control register 27C. Designation addresses for the switching control register 27C are represented by C to C+j in FIG. 4. They means areas prepared in advance in order to, when there are control registers for setting control states and operation modes or the like of circuits excluding the controllers 23 and 24 lying inside the communication control LSI chip according to the present embodiment, allocate the address for the switching control register 27C as one thereof and allocate addresses for registers to be mounted from now on in consideration of expandability of the system. Addresses for registers provided at general purpose I/O ports to be described later can also be placed in the register areas C to C+j.

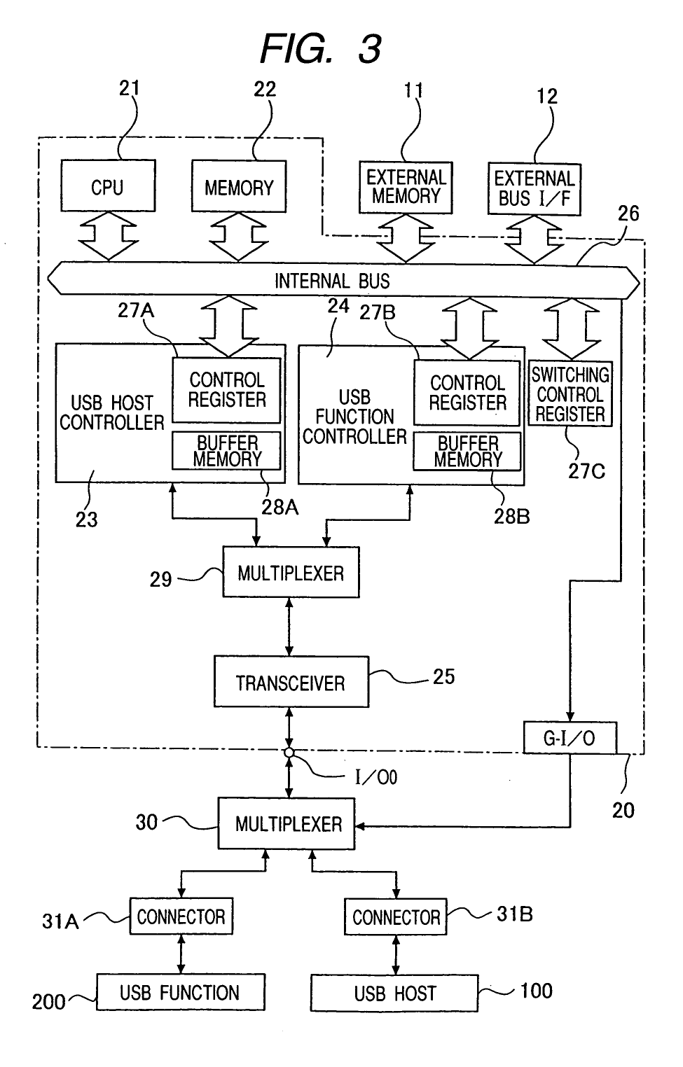

FIG. 3 shows an application of the interface system configured as a board system using the communication control LSI according to the second embodiment.

In the present system, two connectors 31A and 31B are connected via a second multiplexer 30 to the outside of a USB input/output terminal I/O0 connected to a transceiver 25. The multiplexer 30 is switched to make it possible to connect the connector 31A or 31B to the transceiver 25. One connector 31A is a connector connectable to a USB function 200, whereas the other connector 31B is a connector connectable to a USB host 100.

A board is formed for the multiplexer 30 in such a manner that one of general purpose input/output ports G-I/O provided in a chip, for example, is used and an output signal controlled by setting “1” or “0” to an output register lying therein is supplied to a control terminal of the multiplexer 30. Further, the output register in the input/output ports G-I/O is set by the CPU 21 in conjunction with the switching control register 27C.

Namely, when a multiplexer 29 is switched so as to connect a host controller 23 and its corresponding transceiver 25, the multiplexer 30 is switched so as to connect the transceiver 25 and the connector 31A to which the USB function 200 is connectable. When the multiplexer 29 is switched so as to connect a function controller 24 and the transceiver 25, the multiplexer 30 is switched so as to connect the transceiver 25 and the connector 31B to which the USB function 100 is connectable.

In the USB interface system board according to the present application, there are provided the host controller 23, the multiplexer 29 and the switching control register 27C for controlling the state thereof. Further, the board is provided with the connector 31B for connection of each host device, the connector 31A for connection of a function device, and the multiplexer 30 for performing switching between them. Therefore, the host device and the function device are connected to their corresponding connectors in advance, and the setting of the switching control register 27C is simply changed by software as needed, whereby the present system is able to properly communicate with either the host device or the function device connected thereto.

In the system according to this application, the connection switching is capable of connection switching by the setting of the register even without the provision of the means for detecting whether either the host device or the function device is connected. Incidentally, a dedicated terminal for outputting the state of setting of the switching control register 27C to the outside may be provided for its switching instead of using one of the general purpose input/output ports G-I/O provided in the chip in advance as described above as the port for outputting the control signal for performing switching to the external multiplexer 30.

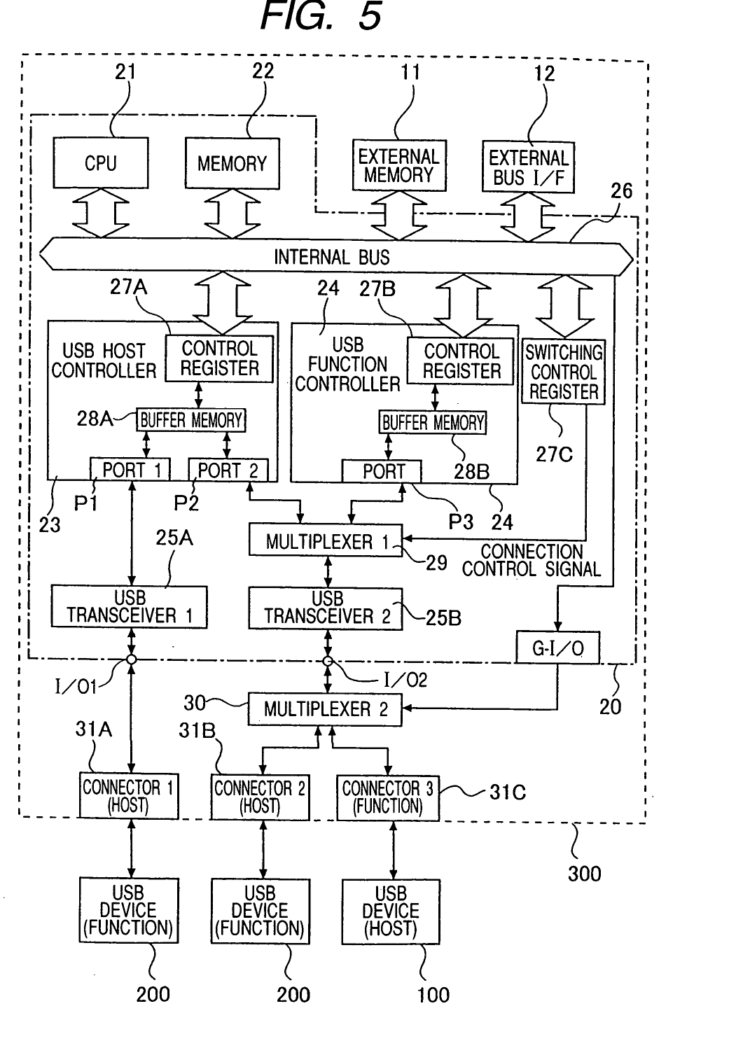

FIG. 5 shows a third embodiment of the present invention. The present embodiment is one utilizing the first embodiment and the second embodiment in combination. The present embodiment shows an example illustrative of a communication control LSI applied to the interface system based on the USB standard, and an interface system using the same.

In the third embodiment shown in FIG. 5, a multiplexer 29 and two transceivers 25A and 25B are provided within a communication control LSI chip 20. Further, a host controller 23 is provided with two ports P1 and P2. The port P1 is connectable to the transceiver 25A, and the port P2 is connectable to the transceiver 25B via the multiplexer 29. The multiplexer 29 is switched and controlled by a switching control register 27C. Each of the ports P1 and P2 is provided with serial-parallel converting means comprising a shift register or the like, which converts parallel data received from a buffer memory 28A into serial data, and converts the serial data into parallel data when the data is delivered to a buffer memory 28B. One port is provided for a function controller 24. The port P3 is also provided with serial-parallel converting means.

A board 300 of the system is provided with connectors 31A and 31B to which USB function devices 200 are respectively connectable, a connector 31C to which a USB host device 100 is connectable, and a multiplexer 30 which performs switching between the connectors 31B and 31C. The transceiver 25A is connectable to the connector 31A, and the transceiver 25B is connectable to the connector 31B or 31C via the multiplexer 30. The multiplexer 30 is controlled in cooperation with the multiplexer 29.

In the present embodiment, when the multiplexers 29 and 30 are switched to the connector 31C side, the function controller 24 is capable of communicating with the host device 100 connected to the connector 31C while the host controller 23 is communicating with the function device 200 connected to the connector 31A. When the multiplexers 29 and 30 are switched to the connector 31B side, the host controller 23 is able to communicate with the function device 200 connected to the connector 31B. In this case, however, the host controller 23 is not able to perfectly and simultaneously communicate with the function device 200 connected to the connector 31A and the function device 200 connected to the connector 31B (it is possible if time division is taken).

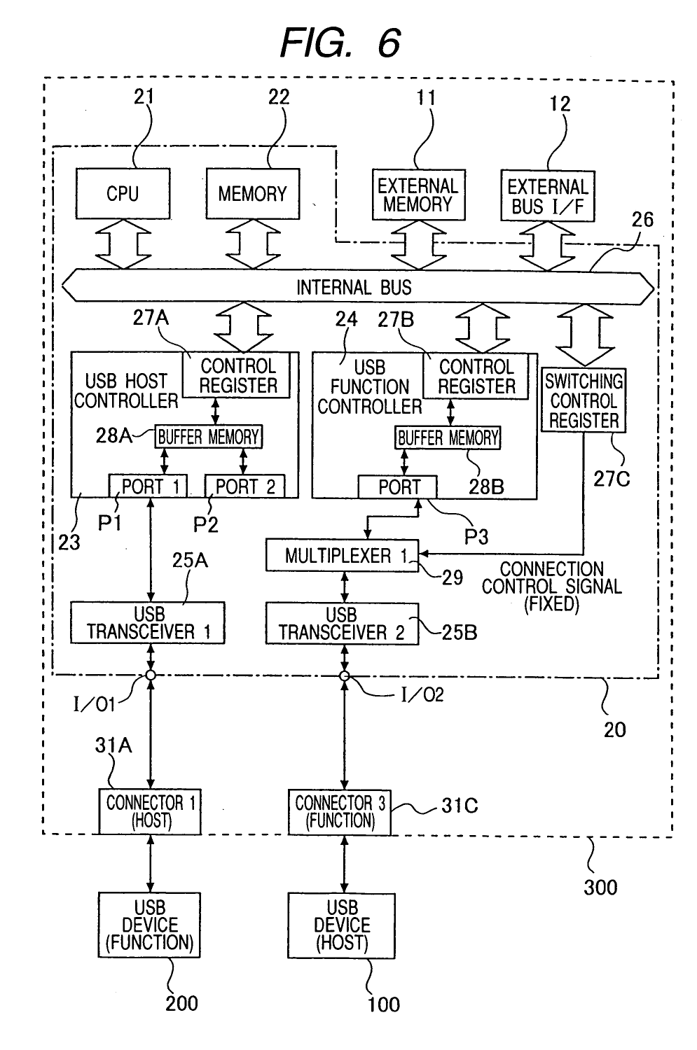

FIG. 6 shows an application of the interface system configured using the communication control LSI according to the third embodiment.

In the present system, a transceiver 25A is connected to a connector 31A connectable to a USB function 200, and a transceiver 25B is connected to a connector 31C connectable to a USB host 100. Although a chip 20 is provided with a multiplexer 29, the multiplexer 29 is set such that a function controller 24 is always connected to the transceiver 25B by a switching control register 27C.

Even in the case of the present application, the function controller 24 is able to communicate with the host device 100 connected to the connector 31C while a host controller 23 is communicating with the function device 200 connected to the connector 31A. Incidentally, since the multiplexer 30 employed in the embodiment of FIG. 5 is unnecessary, the signal for controlling the multiplexer 30 is also unnecessary in the application shown in FIG. 6. Here, an advantage is brought about in that the general purpose input/output ports G-I/O are used to control the multiplexer 30 in the embodiment of FIG. 5. In other words, when there is provided a dedicated terminal for outputting the signal for controlling the multiplexer 30 lying outside the chip, based on the state of the switching control register 27C, the present terminal goes to waste where such a system as shown in FIG. 6 is configured, whereas if the general purpose input/output ports G-I/O are utilized, no needless terminals are generated where such a system as shown in FIG. 6 is configured.

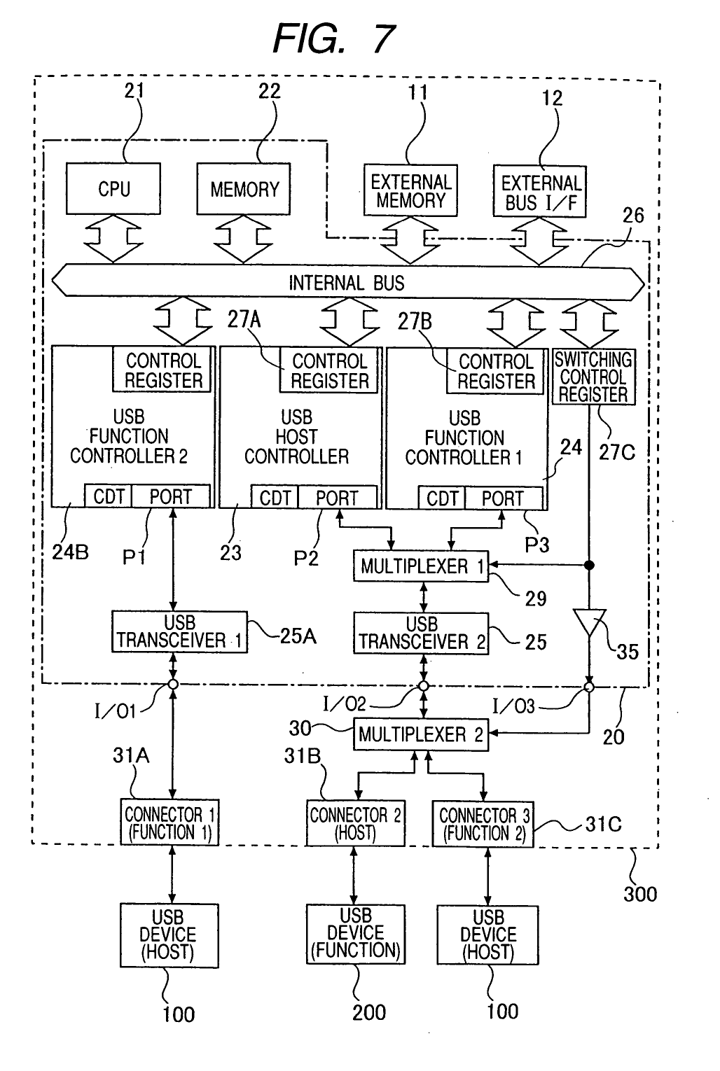

FIG. 7 shows a modification of the third embodiment shown in FIG. 5.

The host controller 23 is configured so as to have the two ports P1 and P2 in the embodiment of FIG. 5, whereas in FIG. 7, one having one port P2 is used as a host controller 23, and a second function controller 24B is provided corresponding to a port P1. The present modification is similar in operation and operative effect to the embodiment shown in FIG. 5. The function controller 24B may be one having a configuration identical to that of the function controller 24 having the port P3.

Also the modification illustrated in FIG. 7 is configured so as to obtain a signal for controlling a multiplexer 30 lying outside a chip from a switching control register 27C without obtaining it from the general purpose input/output ports G-I/O. Therefore, the embodiment shown in FIG. 7 is provided with a buffer 35 and an output terminal I/O3 used for outputting a control signal supplied to a multiplexer 29 lying inside the chip to the outside of the chip. Further, in the present embodiment, an external bus interface circuit 12 is provided within the communication control LSI chip 20. The external memory 11 shown in FIG. 1 is connected via the external bus interface circuit 12.

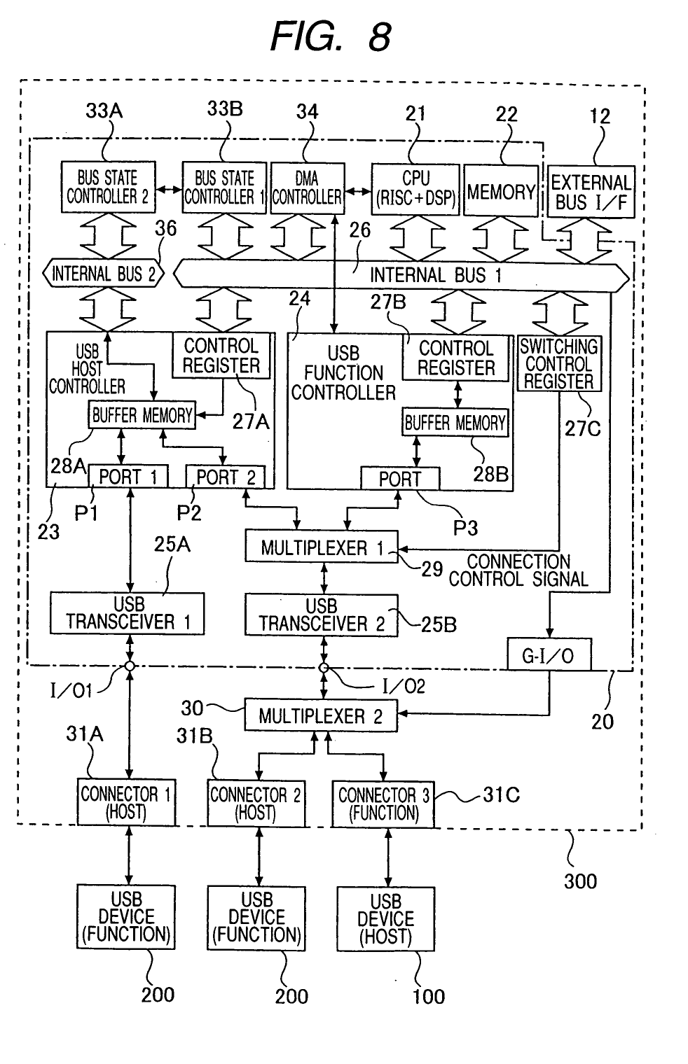

FIG. 8 shows a fourth embodiment of the present invention. The present embodiment is related to an improved one of the third embodiment shown in FIG. 5. The present embodiment shows an example illustrative of a communication control LSI based on the USB standard, and an interface system using the same.

In any of the first through third embodiments, as described above, the data transfer has been carried out through the buffer memory 28A and the control register 27A. On the other hand, in the present embodiment, a host controller 23 is configured in such a manner that data is transferred between ports P1 and P2 and an internal bus via a buffer memory 28A alone without via a control register 27A. Thus, the transfer of data at high speed can be carried out as compared with the aforementioned embodiments.

Incidentally, the transfer of data is carried out through the a buffer memory 28B and a control register 27B on the function controller 24 side in a manner similar to the embodiment referred to above. Owing to the connection of the buffer memory 28B to an internal bus 26 via the control register 27B without being directly connected to the internal bus 26 in this way, a port for connecting the controller and the internal bus may be one and a circuit can be configured in a compact form. Since the host controller 23 is required to have a high-speed data transfer as compared with the function controller 24, data is transferred without via the control register 27A on the host controller 23 side in the present embodiment.

However, the function controller 24 may also be configured in such a manner that the buffer memory 28B is directly connected to the internal bus 26, and the transfer of data between the port P3 and the internal bus 26 is carried out via the buffer memory 28B alone without via the buffer memory 27B, in a manner similar to the host controller 23 side. Thus, the function controller 24 is also capable of performing the transfer of data at high speed.

In order to make it possible to smoothly carry out the transfer of data, the present embodiment is provided with a data internal bus 36, a bus controller 33A for controlling the data internal bus 36, and a bus controller 33B for controlling the internal bus 26 on the CPU side in isolation from the internal bus 26 connected to the control registers 27A and 27B. The data outputted from the buffer memory 28A onto the data internal bus 36 is transferred to the internal bus 26 via the bus controllers 33A and 33B. Further, in the present embodiment, a DMA controller 34 is provided to make it possible to perform the transfer of data between a memory 22 and the control register 27B of the function controller 24.

Moreover, in the present embodiment, the CPU 21 used as third control means is made up of an RISC type CPU core and a DSP (Digital Signal Processor) although not restricted in particular. Thus, a communication control LSI and an interface board can be realized which are suitable for the constitution of a multimedia-compatible system capable of processing image data and voice data at high speed.

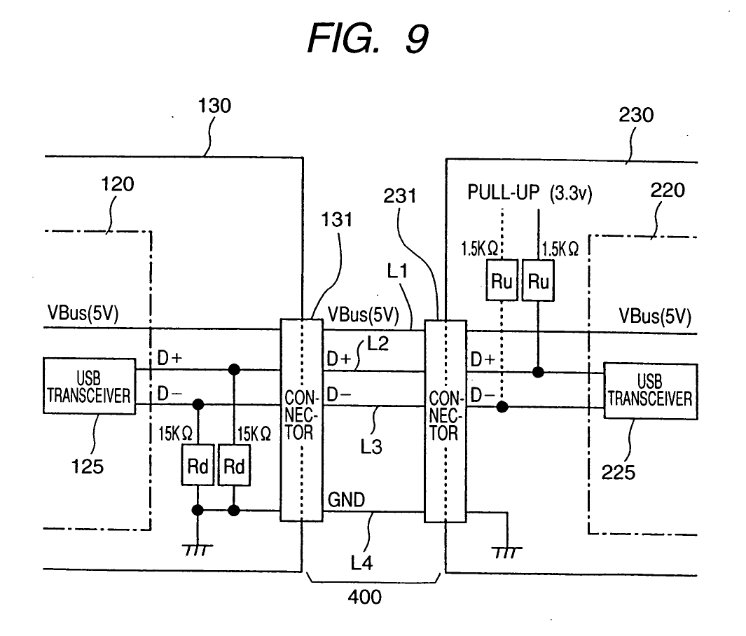

FIG. 9 shows the specification of a cable based on the USB standard, and a connecting method thereof. In FIG. 9, reference numeral 130 denotes an interface board on the USB host device side, reference numeral 230 denotes an interface board on the USB function device side, and reference numerals 131 and 231 respectively denote connectors to which a cable 400 is connected. The connector 131 called “type A” provided in the interface board 130 on the host side, and the connector 231 called “type B” provided in the interface board 230 on the function side are respectively different in shape and configured so as to be able to prevent their false connections.

As shown in FIG. 9, the cable 400 based on the USB standard comprises a power supply line L1 for supplying a power supply voltage of 5V called “VBus”, data lines L2 and L3, and a ground line L4 for supplying a ground potential GND. Of these lines, the data lines L2 and L3 are connected to their corresponding transceivers 125 and 225 of communication control LSIs 120 and 220 on the individual boards. Also the ground line L4 is connected to a source or power supply voltage terminal and a ground terminal on the respective boards. The power supply line L1 is connected to the source voltage terminal on the interface board 130 on the USB host device side.

Further, the data lines L2 and L3 are connected to the ground potential GND through a pull-down resistor Rd of 15 kΩ on the interface board 130 on the USB host device side. The data line L2 or L3 is connected to a power supply voltage like 3.3V through a pull-up resistor Ru of 1.5 kΩ on the interface board 230 on the USB function device side. Incidentally, the pull-up connections of the data lines L2 and L3 on the interface board 230 on the USB function device side are alternative. Either L2 or L3 is pull-up connected depending on whether the corresponding device performs communications at either a high speed (12 Mbps) or a low speed (1.5 Mbps).

Incidentally, a hub used for connecting a plurality of USB function devices to the USB host device is also provided with such a configuration as shown in FIG. 9. A function connection side port (downstream port) of the hub is set to a configuration similar to the interface board 130 on the USB host device shown in FIG. 9. A host connection side port (upstream port) of the hub is set to a configuration similar to the interface board 230 on the function side shown in FIG. 9.

The interface board 130 on the host side detects whether the potential on either the data line L2 or L3 is raised to near 3V to thereby detect whether the cable is connected to the connector 131. The interface board 230 on the function side detects whether the power supply line L1 (VBus) reaches a potential like 3.3V to thereby detect whether the cable is connected to the connector 231.

As indicated by symbols CDTs in FIG. 7 by way of example, circuits for detecting the state of connections of such a cable as described above are provided within or along with the ports P1 through P3 of the host controller 23 and function controllers 24 and 24B in the communication control LSI 20 of each board. In place of the ports for the controllers, cable connected-state detecting circuits may be provided in the transceivers (25A, 25B, 125 and 225).

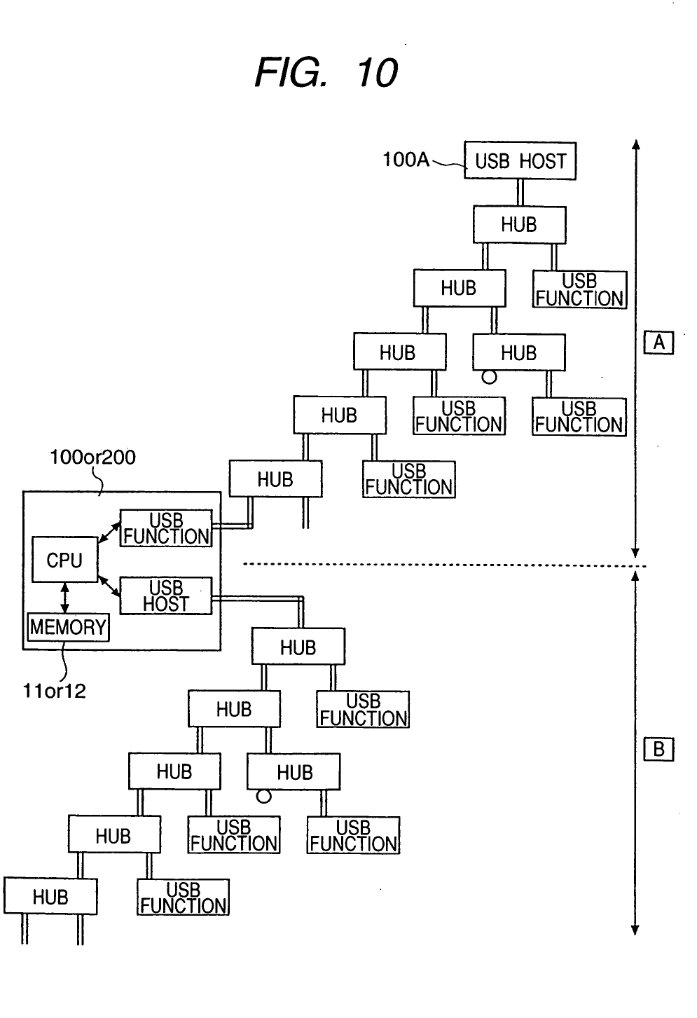

Next, the way to connect a plurality of USB devices each provided with the USB interface board using the communication control LSI according to the above embodiment where the USB devices are connected to one another to configure a network, will be explained using FIG. 10.

The USB standard is provided with the constraint that function devices are respectively connected to host devices in a tree form via relay devices or repeaters called hubs to thereby assure the connections of 127 USB devices at the maximum up to five stages at the maximum. The conventional USB device was able to construct only such a network as indicated by symbol A in FIG. 10. On the other hand, when the USB devices each provided with the USB interface board using the communication control LSI according to the present invention are used, a USB device 100 or 200 to which the present invention is applied, is interposed in a fifth stage as counted from a USB host device 100A as shown in FIG. 10, for example, whereby 127 USB devices corresponding to five stages can further be connected as indicated by symbol B. By repeating it, an infinite of USB devices can be connected theoretically.

Besides, in such a network as shown in FIG. 10, the USB host device 100A at the top of the area of A, for example, is capable of controlling and communicating with the USB devices in the area of B. Therefore, a network can be constructed which is high in the degree of freedom and larger-sized as compared with the conventional one. Incidentally, when data is transferred between the USB host device 100A at the top of the area of A and each USB device lying in the area of B, the data is temporarily stored in a memory 11 or 22 lying within the USB device 100 or 200 to which the present invention is applied, after which its data transfer is carried out.

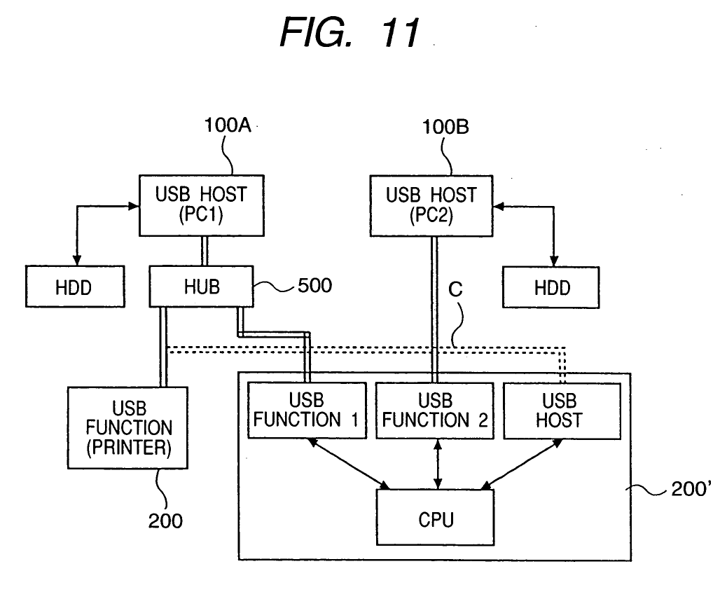

FIG. 11 shows an applied system of a USB device to which the embodiment of FIG. 7 is applied. In FIG. 11, reference numerals 100A and 100B denote USB host devices like personal computers. HDDs indicate peripheral devices like hard disk drivers provided in the respective USB host devices. Reference numeral 500 indicates a USB hub, reference numeral 200 denotes a general USB function device like a printer based on the USB standard, for example, and reference numeral 200′ denotes the USB device to which the embodiment of FIG. 7 is applied. As the USB equipment 200′, may be considered, for example, PDA (Personal Digital Assistants), an electronic still camera, or the like.

In FIG. 11, the USB host device 100A is connected to the function controller 24 side of the USB device 200′ to which the embodiment of FIG. 7 is applied, via the USB hub 500. The USB host device 100B is connected to the function controller 24B side of the USB device 200′ to which the embodiment of FIG. 7 is applied. According to such connections, for example, data stored in the hard disk HDD for the USB host device 100A can be transferred to the hard disk HDD for the USB host device 100B via the USB device 200′. That is, a plurality of USB host devices can hold a resource in common with one another.

Further, if described by the illustration of FIG. 11, a cable for the USB function device 200 is disconnected from the hub 500 and instead connected to a connector on the host controller side of the USB device 200′ as indicated by a broken line C, whereby data can be directly transferred from the USB device 200′ to the USB function device 200. Thus, the data is transmitted from the USB device such as the PDA or electronic still camera to the USB printer, where the data can be printed out. Also image data is transferred from a video camera like an MPEG camera to the PDA, where moving pictures may be reproduced on a display unit of the PDA.

Further, if the USB function device 200 shown in FIG. 11 is also provided with the function controller and the host controller in a manner similar to the USB device 200′, then the cable remains non-disconnected from the hub 500 and another cable is used to connect the USB devices 200 and 200′, whereby the USB function device 200 is capable of directly transferring data to the corresponding USB device.

According to the present invention, as described above, an advantageous effect is obtained in that a communication control LSI and an interface system capable of constructing a free network system beyond the original constraint set based on the interface standard such as the USB standard can be realized, and a communication control LSI and an interface system both capable of transmitting/receiving data without re-connecting a cable or between predetermined devices that could not be connected so far, can be realized.

While the invention made above by the present inventors has been described specifically based on the illustrated embodiments, the present invention is not limited to the embodiments. It is needless to say that various changes can be made thereto within the scope not departing from the substance thereof. Although one host controller 2 and the two function controllers are provided in the embodiment of FIG. 7, for example, one function controller and two host controllers may be provided.

Although each of the above-described embodiments has described a case in which transceivers that perform the transmission/reception of a signal are formed on the same chip as host and function controllers, the transceivers may be configured as semiconductor integrated circuits. Further, although the embodiment referred to above has described a case in which a connector connected to a host device and a connector to which a function device is connected, are different in shape, it is needless to say that the present invention can be applied even to a case in which the connector are identical in shape.

### INDUSTRIAL APPLICABILITY

While the above description has principally been made of the case in which the invention made by the present inventors is applied to a communication control LSI constituting an interface system based on the USB standard, which belongs to the field of application corresponding to the background of the invention, the present invention can be applied even to a case in which a communication control LSI constituting an interface system based on the IEEE1394 standards or a communication control LSI constituting a system having both an interface function based on the USB standard and an interface function based on the IEEE1394 standards is configured.

1. A communication control semiconductor device which constitutes an interface system for transmitting and receiving data between computers and peripheral devices, or between the computers or between the peripheral devices, comprising:
first control means which performs communication control as a master device; and
second control means which performs communication control as a slave device,
said first control means and said second control means being mounted on one semiconductor chip,
wherein the first control means and the second control means are configured so as to be able to operate simultaneously.

2. The communication control semiconductor device according to claim 1, further comprising: a first buffer memory which temporarily stores data transmitted/received by the first control means; and a second buffer memory which temporarily stores data transmitted/received by the second control means,
wherein the first control means and the second control means are respectively provided with control registers set by third control means, the first control means and the second control means are connected to the third control means via an internal bus, and the first buffer memory and the second buffer memory are indirectly connected to the internal bus via the control registers.

3. The communication control semiconductor device according to claim 1, further comprising: a first buffer memory which temporarily stores data transmitted/received by the first control means; and a second buffer memory which temporarily stores data transmitted/received by the second control means,
wherein the first control means and the second control means are respectively provided with control registers set by third control means, the first control means and the second control means are connected to the third control means via an internal bus, the first buffer memory is directly connected to the internal bus, and the second buffer memory is indirectly connected to the internal bus via the corresponding control register.

4. A communication control semiconductor device which constitutes an interface system for transmitting and receiving data between computers and peripheral devices, or between the computers or between the peripheral devices, comprising:
first control means which performs communication control as a master device;
second control means which performs communication control as a slave device;
an input/output terminal to and from which each of data signals transmitted/received according to communication control operations of these control means is inputted/outputted;
switching means connected to the input/output terminal and capable of switching a path through which a transmit/receive data signal passes upon communications under the control of the first control means, and a path through which the transmit/receive data signal passes upon communications under the control of the second control means; and
a switching control register which controls the state of the switching means.

5. The communication control semiconductor device according to claim 4, further comprising third control means which effects a setting on the switching control register.

6. The communication control semiconductor device according to claim 4 or 5, wherein the first control means and the second control means are respectively provided with control registers set by the third control means, and these control registers and the switching control register are respectively placed in different positions in an address space of the third control means.

7. The communication control semiconductor device according to claim 5 or 6, wherein the first control means and the second control means are connected to the third control means via an internal bus and respectively provided with a first buffer memory which temporarily stores data transmitted/received by the first control means, and a second buffer memory which temporarily stores data transmitted/received by the second control means, the first buffer memory is directly connected to the internal bus, and the second buffer memory is connected to the internal bus via the control register.

8. The communication control semiconductor device according to any of claims 4 to 7, further including a first input/output terminal to and from which a transmit/receive data signal is inputted/outputted, and a second input/output terminal to and from which a transmit/receive data signal is inputted/outputted,
wherein the first control means is provided with a first port corresponding to the first input/output terminal and a second port corresponding to the second input/output terminal, and the second port and a port of the second control means are configured so as to be connectable to the second input/output terminal via the switching means.

9. The communication control semiconductor device according to any of claims 4 to 7, further comprising one first control means, two or more second control means, and three or more input/output terminals to and from which a transmit/receive data signal is inputted/outputted,
wherein the first control means and one of the two or more second control means are connectable to any one of the input/output terminals via the switching means.

10. An interface system, comprising:
a communication control semiconductor device as described in any of claims 4 to 7;
a first connector connectable to a host device;
a second connector connectable to a function device; and
external switching means connected between a transmit/receive data input/output terminal of the communication control semiconductor device and the first connector and the second connector,
wherein the external switching means is configured so as to be controlled in conjunction with the switching means provided inside the communication control semiconductor device.

11. An interface system, comprising:
a communication control semiconductor device as described in claim 8 or 9;
a first connector connectable to a host device;
two or more second connectors connectable to a function device; and
external switching means connected between a transmit/receive data input/output terminal of the communication control semiconductor device and any one of the second connectors,
wherein the external switching means is configured so as to be controlled in conjunction with the switching means provided inside the communication control semiconductor device.

12. The interface system according to claim 10 or 11, wherein the external switching means is configured such that a connected state is switched by a signal outputted from a general purpose port provided in the communication control semiconductor device.

13. The interface system according to claim 10 or 11, wherein the external switching means and the switching means provided inside the communication control semiconductor device are configured such that connected states are switched based on a common control signal outputted from the switching control register provided inside the communication control semiconductor device.
